(19) United States
(12) Patent Application Publication
(10) Pub. No.: US 2006/0007554 A1
(43) Pub. Date: Jan. 12, 2006

(54) Method and apparatus for maintaining focus and magnification of a projected image

(76) Inventors: Joerg Ferber, Angerstein (DE); Berthold Burghardt, Waake (DE); Frank Simon, Goettingen (DE)

Correspondence Address: STALLMAN & POLLOCK LLP, SUITE 2200, 353 SACRAMENTO STREET, SAN FRANCISCO, CA, 94111, US

(21) Appl. No.: 11/175,247

(22) Filed: Jul. 6, 2005

Related U.S. Application Data
(60) Provisional application No. 60/586,191, filed on Jul. 8, 2004.

(51) Int. Cl. G02B 27/14

(52) U.S. Cl. 359/630

(57) ABSTRACT

A method for operating an optical projection system including projection optics is disclosed. The projection optics project an image of the object on the substrate at an image distance from the projection optics. The image has a size dependent on the size of the object and the ratio of the image distance to the optical distance of the object from the projection optics. The image distance can change with changes in the condition of the projection optics such as changes in the temperature of elements of the projection optics. The image distance is monitored. If the image distance changes, the substrate is moved to the new image distance and the optical distance of the object is correspondingly changed such that the ratio of the image distance to the object distance stays the same.

### PRIORITY

This application claims the benefit of U.S. Provisional Application No. 60/586,191 filed Jul. 8, 2004, the disclosure of which is incorporated herein by reference.

### TECHNICAL FIELD OF THE INVENTION

The present invention relates generally to using an optical projection system for projecting an image of a mask or reticle on a workpiece in laser material processing applications. The invention relates in particular to a method and apparatus for maintaining the projected image in focus while maintaining a predetermined dimension of the image independent of temperature-induced changes of the properties of the optical projection system.

### DISCUSSION OF BACKGROUND ART

Ultraviolet (UV) laser radiation is often used in laser material processing applications. In several such operations material must be processed in a particular pattern. This is usually accomplished by making a (negative) mask or reticle representing a desired pattern and projecting an image of the mask on the material being treated (workpiece or substrate). One such application is found in the manufacture of flat panel thin film transistor (TFT) displays. This application is laser crystallization of amorphous silicon (Si) films that have been deposited on a glass substrate. In one operation in such an application, the mask image is repeatedly projected over the total area of the flat panel so that all or most of the panel is crystallized in accordance with the projected features of the mask. One preferred method of laser crystallization is the sequential lateral solidification (SLS) process. This is a two-pulse method. First, a line-pattern structure is imaged onto the substrate with a first laser pulse. Then, non-illuminated area between lines of the image are illuminated with a second laser pulse, after correspondingly moving the substrate. In order to obtain good panels, high image quality, homogeneity and reproducibility are required, i.e., constant and homogeneous energy density, well-resolved line patterns, and well-defined dimensions in the image. As the resolution of flat-panel displays is increased, these requirements will become more stringent.

One problem that arises during the projection operation is that a portion of the UV radiation being projected can be absorbed by optical elements of the optical projection system increasing the temperature of the elements and thereby changing imaging properties of the optical system. One significant such change is a shift of the image plane, i.e., the plane in which the image is in optimum focus, of the optical system either toward or away from the plane in which the workpiece is located. The shift referred to here is a shift in the direction of the longitudinal or z-axis of the optical system. In the absence of any compensation scheme for such an image-plane shift, definition of features can vary over the display.

A commonly used such prior-art compensation scheme involves mounting the substrate on a platform that is movable along the z-axis, monitoring the focus position, (the image plane position), during the operation, and, if a change in the focus position is detected, moving the substrate-carrying platform along the z-axis to the changed focus position. A shortcoming of this method is that changing substrate position to match the image plane shift changes the ratio of the image distance to the object distance of the optical system, i.e., changes the magnification of the optical system. The image distance, here, being the z-axis distance of the image plane position from the optical system, and the object distance being the z-axis distance of the mask being projected from the optical system.

It is also possible to attempt stabilize the temperature of the optical elements by including projection optics in a temperature controlled enclosure. In theory at least, this should prevent image shift. In practice, however, the change in temperature of individual elements of the projection optics due to absorbing the laser radiation will usually occur far more rapidly than the temperature can be stabilized by the enclosure. To partially compensate for this, the image-plane-shift tracking and temperature control can be used in combination, this however, will still cause image distance and magnification change. Accordingly, there is a need for a focus (image distance) tracking and compensation method that not only maintains a substrate at a position of best focus, but also maintains the magnification of the optical system constant during this focus tracking and compensation.

### SUMMARY OF THE INVENTION

The present invention is directed to apparatus for projecting an image of an object on a substrate. In one aspect, apparatus in accordance with the present invention comprises projection optics for projecting the image of the object on the substrate. The object is located at an object distance from the projection optics, and the focused image is located at an image distance from the projection optics. The image distance can vary, as discussed above, with variations in the condition of the projection optics such as the temperature of elements of the projection optics. A substrate shifter is provided for varying the distance of the substrate from the projection optics. An object distance varying arrangement is provided for varying the optical distance of the object from the projection optics. A focus monitor is provided for monitoring the distance of the image from the projection optics as that distance changes with changes of the condition of the projection optics. A controller cooperative with the focus monitor, the substrate shifter, and the object distance varying arrangement is arranged to maintain the substrate at the image distance as conditions of the projection optics vary, and to maintain a constant ratio of the image distance to the object distance.

In one preferred embodiment of the inventive apparatus, the physical distance of the object from the projection optics is fixed. The optical distance varying arrangement includes two transparent counter-wedges located between the object and the projection optics. The optical distance of the object from the counter-wedges is varied by varying the lateral position of the wedges with respect to each other such that the total thickness of the wedges in the beam varies. In this arrangement, the focus monitor monitors the image distance through the projection optics and the counter wedges.

### BRIEF DESCRIPTION OF THE DRAWINGS

The accompanying drawings, which are incorporated in and constitute a part of the specification, schematically illustrate a preferred embodiment of the present invention, and together with the general description given above and the detailed description of the preferred embodiment given below, serve to explain the principles of the present invention.

FIG. 1 schematically illustrates one preferred embodiment of apparatus in accordance with the present invention, including projection optics projecting an image of a mask on a substrate mounted on an axially movable platform at a focal distance from the projection optics, a focus monitor for determining the focal distance, a controller cooperative with the focus monitor for moving the substrate to maintain the substrate at the focal distance if the focal distance changes with operating conditions of the projection optics, and two wedges located between the mask and the projection optics, the wedges being movable by the controller with respect to each other for varying the optical distance of the object from the projection optics and thereby maintaining a fixed ratio of focal distance to object distance as the focal distance changes.

FIG. 1A schematically illustrates details of the object-distance varying wedges of FIG. 1.

FIG. 2 schematically illustrates one preferred embodiment of apparatus in accordance with the present invention, similar to the apparatus of FIG. 1, but further including a substrate height tracking arrangement for detecting changes in distance from projection optics to substrate as the substrate is translated transverse to the optical axis of the projection optics in step-and-repeat or scanning operations.

### DETAILED DESCRIPTION OF THE INVENTION

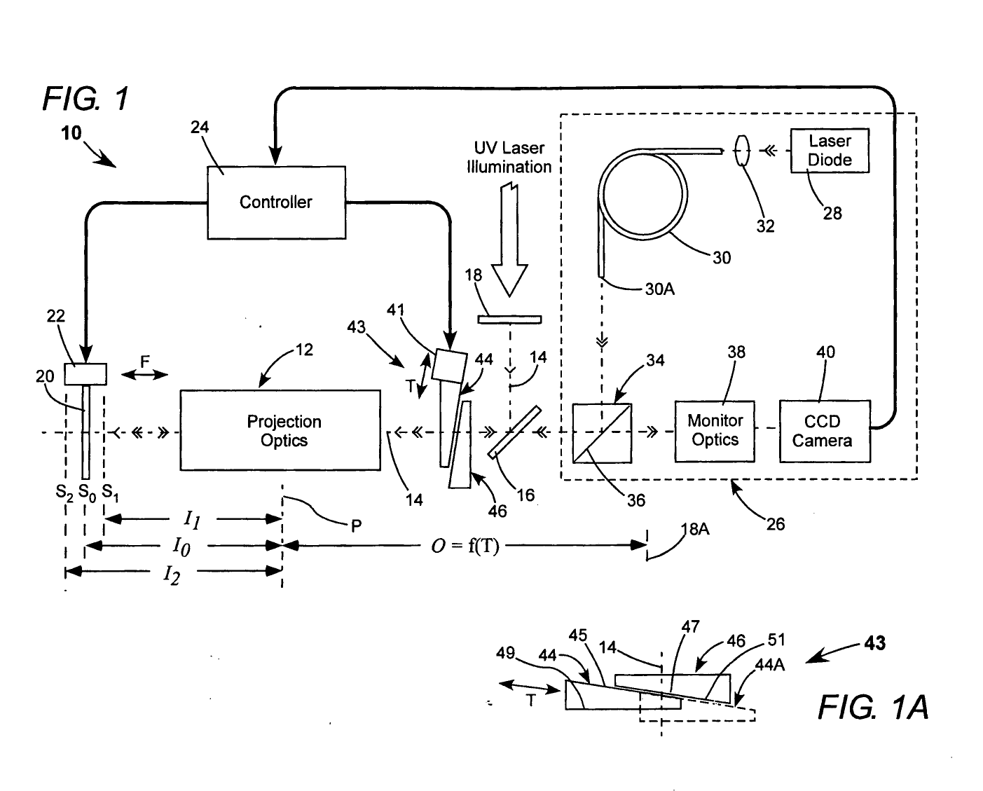

The FIG. 1 and FIG. 1A schematically illustrate a preferred embodiment 10 of apparatus in accordance with the present invention. Apparatus 10 includes projection optics 12 having a longitudinal optical axis (z-axis) 14 folded by a dichroic mirror 16. A mask 18, an image of which is to be projected, is located on the optical axis and illuminated by UV light from a laser and illumination optics (not shown). The general direction of propagation of UV light from the illuminated mask is indicated by single arrowheads. Projection optics 12 forms an image of the mask on a substrate (workpiece) 20 located at a position S₀ at a focal distance I₀ from a principal plane P of the projection optics. Substrate 20 is held on a platform 22, which is movable in forward and reverse directions along optical axis 14, responsive to commands from a system controller 24 as indicated by arrows F. Those skilled in the art will recognize that while the term “focus position” is used herein to describe position S₀, and the term “focal distance” is used to describe distance I₀, this distance I₀ is not necessarily the “focal length” of the projection optics, but is the distance from the optics of one conjugate focus of the optics, corresponding to a corresponding conjugate focus of the optics in which mask 18 is located. That distance can be referred to in the alternative as an image distance, being the distance at which an optically defined (focused) image is located from the projection optics.

A focus monitor 26 is provided for determining the degree of focus of the projection optics at the instant location of substrate 20 and thereby providing a measure of the image (focal) distance. This focus monitor employs a well-known method of wavefront measurement for determining focus position. The focus monitor 26, here, includes a laser-diode 28. The general propagation direction of light delivered by the laser diode is indicated by double arrowheads. Light from the laser diode is focused into a single-mode optical fiber 30 by coupling optics 32. The laser diode-light is transported by the fiber and directed to a beamsplitter 34. Beamsplitter 34 in this example is in the form of a cemented bi-prism, but that should not be considered as limiting the present invention.

A portion of the laser diode light is reflected from beamsplitting surface 36 of the bi-prism and is transmitted through dichroic mirror 16 along axis 14 of the projection optics, and through two wedges 44 and 46, the purpose of which is discussed further hereinbelow. The projection optics image the laser diode-light, i.e., the exit face 30A of fiber 30, onto the substrate. Diode-laser light is reflected from the substrate and returns through the projection optics, through wedges 44 and 46, and through dichroic mirror 16 to beamsplitter bi-prism 34. A portion of the laser diode light is transmitted by beamsplitting surface 36 of the bi-prism to monitor optics 38. In monitor optics 38, the laser diode light is collimated then focused onto a CCD chip (camera) 40 by a cylindrical lens array (not shown) as an image including two parallel lines. The separation distance between the parallel lines provides a measure of the focus position of the projection optics. Controller 24 processes data from CCD camera 40 to determine the line separation and adjusts the position of platform 22 to maintain substrate 22 at the optimum focal distance. The inventive system is typically used in repeated imaging operations on substrates having the same nominal thickness, and the system is calibrated prior to use for that nominal substrate thickness, such that the front surface of the substrate is what is maintained at the focal distance.

It should be noted here that the wavefront-measurement method of determining focus position is well known in the art, and the forgoing brief discussion of focus monitor 26 is presented merely for completeness of description. This particular focus monitor arrangement should not be construed as limiting the present invention. Several other focus monitoring arrangements for driving what may be described as “auto-focus” mechanisms are also well known in the optical art. One skilled in the art may incorporate any one of these arrangements in the inventive apparatus without departing from the spirit and scope of the present invention. The wavefront-measuring focus monitor was found to be capable of a image distance resolution of less than about ±2.0 micrometers (μm) over a range of about 100 μm for an object-to-image distance of about 800 millimeters (mm). Other focus monitor types may provide a different resolution.

As discussed above, a principal object of the present invention is to provide not only a device that maintains a mask image in focus on a substrate or workpiece, but to provide also that this focus is maintained without the image size being changed as a result of any optical system changes necessary to maintain the image in focus. The image size is determined by the mask size and the magnification of the optical system including the projection optics. A measure of this magnification is the ratio of the optical distances of the mask (object) and the image from a principal plane of the projection optics. A principle feature of the present invention is that means are provided to enable this image-distance:object-distance ratio to be maintained constant as the image distance is changed to track thermally-induced or other changes in the focal distance (image distance) during operation of the apparatus. It should be noted, that the term “magnification” is used here in a formal sense. Those skilled in the art will recognize that in a system of the type described, the image size will be usually be less than the mask size, i.e., the magnification will usually have a value less than 1.0. This, of course, should not be considered as limiting the present invention.

In apparatus 10, the position of mask 18 with respect to principle plane P is assumed to be fixed, i.e., the physical distance of the object from the projection optics is fixed. An arrangement 43 is provided for varying the optical distance of the mask from plane P. The optical distance depends on the physical distance and on the refractive index and thickness of any transparent elements located within the physical distance. In this arrangement, the optical distance can be varied by altering, by means of an actuator 41, the position transverse to optical axis of two identical transparent wedges 44 and 46 with respect to each other, as indicated in the FIGS. 1 and 1A by arrows T. The wedges are located between the mask and the projection optics and arranged transversely across axis 14. The vertices of the wedges are opposed and each wedge has the same wedge angle. Hypotenuse faces 45 and 47, of wedges 44 and 46, respectively, face each other and are parallel to each other, and outer faces 49 and 51 of the wedges are also parallel to each other Such opposed wedges are often referred to as counter-wedges by practitioners of the art, and provide for varying the thickness of material through which a beam must pass without varying the tilt of the beam or varying any lateral translation of the beam.

Moving the wedges laterally closer to, or further from each other respectively increases or decreases the thickness of wedge material in the path of light from the mask. This is illustrated in FIG. 1A wherein wedge 44 is depicted in two different lateral (with respect to longitudinal axis 14) positions, with one position 44A thereof shown in phantom. This increase or decrease of the wedge material thickness effectively, respectively increases or decreases the object distance. The translation is effected as depicted in FIG. 1A, at an angle (the wedge angle) to a perpendicular to axis 14 such that the distance between the hypotenuse faces remains the same. This prevents changes in any lateral translation of the beam. Because the wedges have the same wedge-angle the beam is not tilted. In FIGS. 1 and 1A, for convenience of illustration, only one actuator is depicted, translating only one wedge with respect to the other. A bigger range of change in combined axial thickness of the wedges can be obtained by translating both wedges in opposite directions. This may, however, require a more complex mechanical arrangement.

This variable object distance is indicated in the FIG. 1 as an optical distance O between principal plane P and an “unfolded” mask position 18A. Distance O is a function of the translation T of wedges 44 and 46 with respect to each other (O=f(T)) or as a function of the thickness of wedge material on optical axis 14. Whatever method of focus monitoring is used, it is preferable that the focus is monitored not only through the projection optics but also through the counter wedges as described above.

Thermally induced changes in projection optics 12 can cause a shift of the focus of the objective from a nominal focus position S₀ at which the substrate is located to a position S₁ closer to principal plane P of the projection optics, or to a position S₂ further from principal plane P. Positions S₀, S₁, and S₂, are at distances (image distances) of I₀, I₁, and I₂, respectively, from principal plane P of the objective, with I₀ being the nominal image distance. It is desired that the system have a fixed magnification M equal to a nominal image distance divided by a nominal object distance.

If a focus shift occurs as a result of thermally-induced changes in the projection optics, focus monitor 26 detects the focus shift. A signal from the focus monitor corresponding to the shift is received by controller 24. In a preferred correction scheme, the controller then calculates, in response to the signal, a new object distance and a new image distance that will provide a focused (optimally sharp) image and a ratio of image-distance:object-distance equal to M. The controller then simultaneously adjusts the object distance the new value and commands actuator 22 to shift the substrate to the new image distance from the projection optics. The controller changes the object distance by commanding controller 41 to translate wedges 44 and 46 with respect to each other to change O to the required value. In another correction scheme, the controller can first shift the substrate to a new image distance, then change object distance O to restore the magnification to M. In this scheme, if the change in distance O is sufficiently great, it is possible that the focal position will again change as a result of changing distance O. If this is the case, the changed focal position is again detected by the focus monitor and the substrate shifting and wedge translation are executed again. The substrate shifting and wedge translation can take place iteratively, if necessary, until a condition is reached where the substrate has a focused image thereon and the magnification is M.

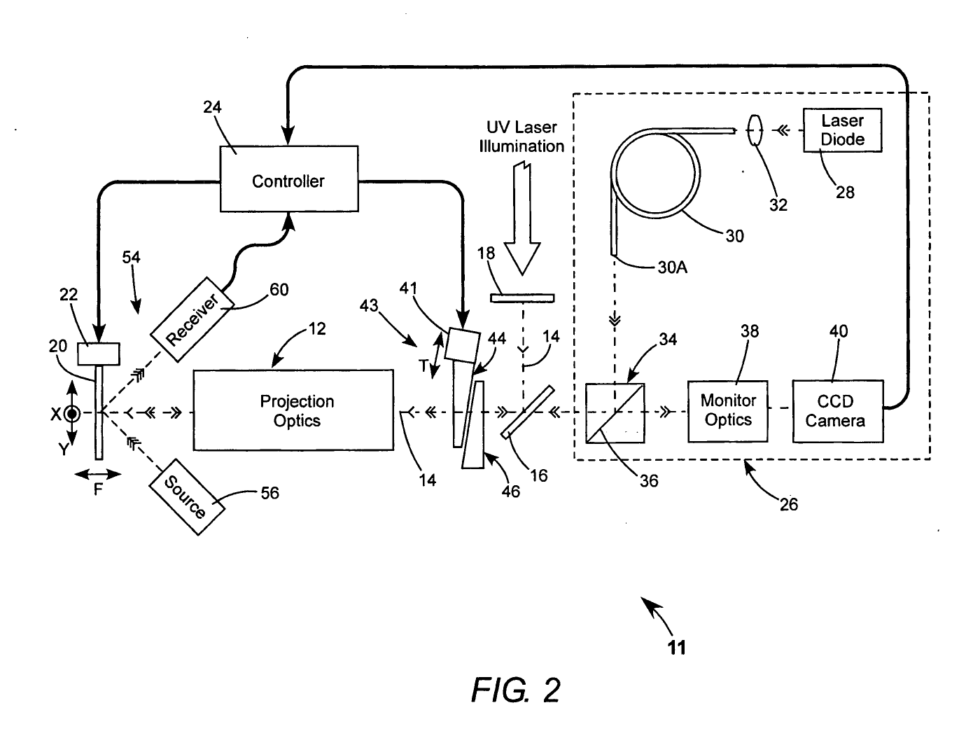

One potential source of inaccuracy of the above-discussed inventive optical system is that changes in the axial distance of the substrate from the projection optics can occur if the substrate is translated transverse to optical axis 14 in scanning or step-and-repeat imaging operations and the substrate surface on which the image is projected is not precisely flat or of constant thickness. Such a distance change could also occur due to differences in thickness between substrates in a batch thereof, i.e., after an exposed substrate was exchanged for a new, un-exposed substrate. In most cases, such changes would be within the potential accuracy of the focus monitor itself, however, a method of compensating for a more significant change can be advantageous. A description of one such method of compensating for such a possible inaccuracy is set forth below with reference to FIG. 2.

FIG. 2 schematically depicts another preferred embodiment 11 of a projection system in accordance with the present invention, similar to system 12 of FIG. 1, but further including a height sensor 54 for detecting changes in substrate height, i.e., the distance from substrate to projection optics, that would occur if substrate 20 were not exactly flat, and the substrate were translated in either the X or Y directions transverse to optical axis 14 between exposures of the substrate to the mask image. In this example height sensor 54 includes a light source 56 and a receiver 58. A beam from the light source is focused on a position detector (not shown) in the receiver. The signal from the detector is transmitted to the controller. Any change of beam position following a translation will be interpreted by the controller as a resulting from a change in substrate distance from the originally calibrated distance. The controller can compensate for this by changing accordingly the axial position of the substrate, i.e., by moving the substrate back to where the image instantly is. It is emphasized, here, that sensor 54 is but one form of substrate-distance determining sensor that can be used with the present invention, and should not be considered as limiting the present invention.

By means of these two independent sensors, (one monitoring image distance through the projection optics and the other measuring the substrate-distance changes), controller 24 can clearly distinguish between effects resulting from changes in properties of the projection lens, and effects resulting from substrate thickness or flatness changes. Changes in properties of the projection lens are compensated for by changing both the object distance and the image distance as described above, in order to hold image focus and magnification constant. Changes in substrate thickness are compensated for by changing only the axial position of the substrate.

In conclusion, the present invention provides a system for projecting an image of a mask on a substrate in which the image size is maintained constant if the distance of the substrate from projection optics of the system is changed to correspond to a monitored operational shift in focus position. This is achieved by providing that the ratio of the optical distance from the substrate to the projection optics to the optical distance to the projection optics is maintained constant as the image distance is changed to refocus the image on the substrate on the substrate. This maintains the magnification of the system, and accordingly the image size, essentially constant.

The present invention is described above with reference to one preferred embodiment. In this embodiment, a wavefront measuring focus monitor is used to determine focal distance, and the image size is maintained essentially constant by varying the optical distance of the mask from the projection optics such that the ratio of the image distance to the optics distance is held constant. Persons of ordinary skill in the art may modify the above-described embodiment without undue experimentation or without departing from the spirit or scope of the present invention. By way of example, a different focus monitor may be employed or a different method of changing the optical distance of the object may be employed. These or any other such departures or deviations, however, should be construed to be within the scope of the claims appended hereto.

What is claimed is:

1. Apparatus for projecting a focused image of an object on a substrate, comprising:
projection optics for projecting the image of the object on the substrate, the object being located at an object distance from the projection optics and the focused image being located at an image distance from the projection optics, the image distance changing with changes in the condition of the projection optics;
a substrate shifter for selectively varying the distance of the substrate from the projection optics;
an object distance varying arrangement for selectively varying the optical distance of the object from the projection optics;
a focus monitor for monitoring the distance of the image from the projection optics as that distance changes with changes of the instant condition of the projection optics; and
a controller cooperative with the focus monitor, the substrate shifter, and the object distance varying arrangement and arranged to maintain the substrate at the image distance as conditions of the projection optics change, and to maintain an essentially constant ratio of the image distance to the object distance.

2. The apparatus of claim 1, wherein the object distance varying arrangement includes first and second transparent wedges arranged on the optical axis of the projection optics between the object and the projection optics, the wedges being arranged with apexes thereof opposed, and the object distance being varied by translating at least one of the wedges with respect to the other such that the total thickness of the wedges on the optical axis is varied.

3. The apparatus of claim 1, wherein each of the wedges have first and second faces including a wedge-angle therebetween, with the wedge-angles of the wedges being equal, the first surfaces of wedges being parallel to each other, the second surfaces of the wedges being parallel to each other, and the translation of the wedges with respect to each other being arranged such that the axial distance between the wedges remains constant.

4. The apparatus of claim 3, wherein the focus monitor is arranged to monitor the image distance through the wedges and through the projection optics.

5. The apparatus of claim 1, wherein the focus monitor is a wavefront-measuring focus monitor.

6. The apparatus of claim 1, wherein the physical distance of the object from the projection optics is fixed.

7. The apparatus of claim 1, further including a sensor arranged cooperative with the controller and the substrate shifter to detect changes in distance of the substrate from the projection optics resulting from translation of the substrate transverse to the optical axis or following substrate exchange, and to change the substrate distance to compensate for such changes, such that the substrate is maintained at the image distance.

8. The apparatus of claim 7, wherein the substrate distance detecting sensor includes a light source arrange to direct a light beam onto the substrate at an angle to the substrate to be reflected therefrom, and a position detector arranged to monitor the position of the reflected beam, a change in position of the reflected beam being representative of the change in substrate distance.

9. Apparatus for projecting a focused image of an object on a substrate, comprising:
projection optics for projecting the image of the object on the substrate, the projection optics having a longitudinal optical axis, the object being located on the optical axis at an object distance from the projection optics and the focused image being located at an image distance from the projection optics, the image distance changing with changes in the condition of the projection optics;
a substrate shifter for selectively varying the distance of the substrate from the projection optics;
first and second transparent wedges arranged on the optical axis of the projection optics between the object and the projection optics, the wedges being arranged with apexes thereof opposed, and the lateral position of the wedges with respect to each other being selectively variable for selectively varying the optical distance of the object from the projection optics;
a focus monitor for monitoring the distance of the image from the projection optics as that distance changes with changes of the instant condition of the projection optics; and
a controller cooperative with the focus monitor, the substrate shifter, and the wedges and arranged to maintain the substrate at the image distance as conditions of the projection optics change, and to maintain an essentially constant ratio of the image distance to the object distance by selectively varying the lateral position of the wedges with respect to each other corresponding to changes in the image distance.

10. The apparatus of claim 9, wherein each of the wedges have first and second faces with a wedge-angle therebetween, with the wedge-angles of the wedges being equal, the first surfaces of wedges being parallel to each other, the second surfaces of the wedges being parallel to each other and the translation of the wedges with respect to each other being arranged such that the axial distance between the wedges is constant.

11. The apparatus of claim 10, wherein the focus monitor is arranged to monitor the image distance through the wedges and through the projection optics.

12. The apparatus of claim 9, further including a sensor arranged cooperative with the controller and the substrate shifter to detect changes in distance of the substrate from the projection optics resulting from translation of the substrate transverse to the optical axis or from substrate exchange, and to change the substrate distance to compensate for such changes such that the substrate is maintained at the image distance.

13. A method of projecting a focused image of a mask on a substrate comprising the steps of:
projecting optical radiation through the mask and onto the substrate through projection optics;
monitoring the focus of the image of the mask on the substrate; and
correcting for changes in focus while maintaining the size of the image on the substrate by a combination of:
a) changing the physical distance between the mask and the substrate; and
b) changing the optical distance between the mask and the projection optics.

14. A method as recited in claim 13, wherein the step of changing the optical distance between the mask and the projection optics is performed by varying the thickness of a transparent optical element located in the path between the mask and the projection optics.

15. A method as recited in claim 14, wherein the step of varying the thickness of a transparent optical element located in the path between the mask and the projection optics is performed by varying the relative position of two opposed wedges formed of transparent material.

16. A method as recited in claim 15, wherein the focus of the image of the mask is monitored through said wedges.

17. A method as recited in claim 13, further including the step of monitoring changes in distance between the substrate and the projection optics resulting from translation of the substrate transverse to the axis of the projected radiation and compensating for such changes by changing the physical distance between the mask and the substrate.
